(19) United States
(12) Patent Application Publication
(10) Pub. No.: US 2013/0307231 A1
(43) Pub. Date: Nov. 21, 2013

(54) PORTABLE SLED AND LITTER, AND METHODS OF ASSEMBLING SAME

(71) Applicants: Jeff Allott, Elizabethtown, NY (US); Jeff Knight, Two Harbors, MN (US); Matthew Griffin, Issaquah, WA (US)

(72) Inventors: Jeff Allott, Elizabethtown, NY (US); Jeff Knight, Two Harbors, MN (US); Matthew Griffin, Issaquah, WA (US)

(21) Appl. No.: 13/474,550

(22) Filed: May 17, 2012

(51) Int. Cl. B62B 15/00

(52) U.S. Cl. 280/18

(57) ABSTRACT

A portable sled and litter is easily and quickly assembled and disassembled, and when disassembled it can fit into a bag or container to be carried by a single person. Further, the portable sled and litter takes the form of a rigid litter (as compared to a non-rigid litter), and includes a plurality of rigid, interlocking panels that cooperate with a frame assembly. An inelastic cord extends through at least several frame assembly members and when tensioned causes the frame assembly members to engage with one another to form the frame assembly or at least a section of the frame assembly. The portable sled and litter may have adjustable and static couplings for tensioning the inelastic cord.

### FIELD OF THE INVENTION

The present invention generally relates to a portable sled and litter, and more specifically to a portable sled and litter that may be quickly assembled and disassembled.

### BACKGROUND OF THE INVENTION

Sled systems or sleds are commonly used in mountainous terrains or deep snow in the backcountry terrain. The ability to remove loads from the individual to a sled increases efficiency in overland movement and reduces fatigue throughout movements. Additionally, a sled enables a person to carry a load in excess of what is possible with a standard pack or load carriage system. Explorers in the Arctic and Antarctic typically tow sleds weighing between 200 to 300 pounds.

The ability to distribute weight over a larger surface area dramatically increases safety in icy or snowy environments. Should a person with a heavy backpack need to cross a questionable piece of ice covered water, the individual would need to go through a several step process to navigate the hazard. Using a sled across ice enables the individual to mitigate risk by distributing weight and removing a potential anchor in the event of a break through.

Sleds increase safety in high angle environments. Individuals are able to fill a sled with heavy or cumbersome gear, lower the load with simple rope systems, and navigate the terrain unhindered. Conventionally, hikers or mountaineers rappel with heavy loads on their backs. This method increases the risk or slips, falls, or entanglements on a descent or ascent.

Throughout the years, non-rigid litters were adapted by the military for casualty evacuations. The ability to roll a plastic litter in a small backpack enabled medics and operators to bring lifesaving equipment closer to the point of injury. Some of these non-rigid litter systems became commonly used in special operational units, conventional military units, and even non-military environments. By way of example, military units have routinely used the SKEDCO® litter system or the FOXTROT® litter system. All of the litter systems enable are providers to quickly package a patient, drag, carry, or move the patient in a high angle or rough terrain environment. Further, the non-rigid litter systems are readily portable and less expensive than conventional, rigid litter systems.

Although non-rigid litters have a great degree of advantages over rigid litters in remote or tactical environments, there are several disadvantages associated with the non-rigid litter systems. The lack of rigidity provides minimal stabilization for patients with spinal injuries, requires more litter bearers to move rapidly above ground, and is slow to rig for a high angle environment. The most frustrating trait of the non-rigid litters is the memory retained by the plastic that forms the litter itself. When a rescuer lays out the device, it needs to be held flat in order to move a patient into position. If the litter is not held on each end, it curls up into its storage position and causes unnecessary assembly delays, which may result in extra time to move the patient. Because of the standard method of dragging a patient, the non-rigid litters often become scored on the bottom, which may result in an operational life of only a few patient movements. In such an instance, the entire litter may need to be disposed of, the plastic, straps, and buckles, and then replaced with a new litter.

### BRIEF SUMMARY OF THE INVENTION

At least one embodiment of the present invention comprises a portable sled and litter that is easily and quickly assembled and disassembled, and when disassembled it can fit into a bag or container to be carried by a single person. Further, the portable sled and litter takes the form of a rigid litter (as compared to a non-rigid litter), and includes a plurality of rigid, interlocking panels that cooperate with a frame assembly. An inelastic cord extends through at least several frame assembly members and when tensioned causes the frame assembly members to engage with one another to form the frame assembly or at least a section of the frame assembly.

In one aspect of the present invention, a portable sled and litter includes a frame assembly having a plurality of telescoping members. At least some of the telescoping members have complementary connectable end portions for engaging with each other. The portable sled and litter further includes an inelastic cord extending through the at least some of the telescoping members, and the inelastic cord has a distal end and a proximal end. The distal end is fixed to a portion of the frame assembly (e.g., fixed to a static coupling), and the proximal end is tensionable (e.g., tensionable by manipulating an adjustable coupling) to bring the complementary connectable end portions of the telescoping members into aligned engagement. Lastly, the portable sled and litter includes a plurality of panels releasably engageable with the frame assembly, and each panel is configured to releasably interlock with at least one adjacent panel.

In another aspect of the invention, a method for assembling a portable sled and litter includes the steps of (1) arranging a plurality of frame members on a surface, the frame members comprising a frame assembly for the portable sled and litter; (2) tensioning an inelastic cord, the cord extending through at least some of the frame members, wherein the tension developed in the cord urges the frame members into an alignable engagement; (3) interlocking a plurality of panels together to form a rigid litter surface; and (4) supporting the interlocked plurality of panels on the frame assembly such that load applied onto the panels transfers to the frame assembly.

### BRIEF DESCRIPTION OF THE DRAWINGS

Preferred and alternative embodiments of the present invention are described in detail below with reference to the following drawings:

FIG. 1 is a perspective view of a portable sled and litter according to an embodiment of the present invention;

FIG. 2 is a perspective, exploded view of a portable sled and litter according to another embodiment of the present invention;

FIG. 3 is a perspective, assembled view of a plurality of panels comprising the portable sled and litter of FIG. 2 according to an embodiment of the present invention;

FIG. 4 is a perspective view of an interlocking panel of the portable sled and litter of FIG. 2 according to an embodiment of the present invention;

FIG. 5 is a close-up view of adjacent panels of the portable sled and litter of FIG. 2 about to be interlocked with each other according to an embodiment of the present invention;

FIG. 6 is a perspective view of the adjacent panels of FIG. 5 with the panels interlocked according to an embodiment of the present invention;

FIG. 7 is a top plan view of a frame assembly for a portable sled and litter according to an embodiment of the present invention;

FIG. 8A is a side, elevational view of a side (straight) portion of the frame assembly of FIG. 7 according to an embodiment of the present invention;

FIG. 8B is a perspective view of an adjustable coupling according to an embodiment of the present invention;

FIG. 8C is a perspective view of a static coupling according to an embodiment of the present invention;

FIG. 9 is a top plan view of a frame assembly according to another embodiment of the present invention; and

FIG. 10 is a side elevational view of a plurality of panels stacked in a nested configuration according to an embodiment of the present invention.

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures associated with sleds and litters to include methods of operating and/or assembling the same may not necessarily be shown or described in detail to avoid unnecessarily obscuring descriptions of the embodiments of the invention.

To address at least some of the aforementioned drawbacks of conventional litters, and in particular conventional rigid litters, at least one aspect of the present invention involves a portable sled and litter that may be quickly assembled and disassembled by one person. The portable sled and litter includes intermediate sections with interlocking tabs and may include end sections also having interlocking tabs. The respective sections may be rotated into engagement with an adjacent section as the tabs are interlocked. In one embodiment, the interlocking tabs are formed in and aligned with one or more structural ribs, gussets or raised, structural protuberances (hereinafter referred to as structural ribs) that generally extend approximately parallel with a direction of travel of the litter, or stated alternatively the structural ribs extend lengthwise with respect to the overall configuration of the portable sled and litter. The sections may include cup-shaped side portions that are configured to receive transfer load to a frame assembly. In turn, the frame assembly may take the form of cylindrical or tubular members each having a metallic, inner tube and a fiber-reinforced outer tube. An inelastic cord extends through an interior of the frame assembly. The inelastic cord is fixed to one of the frame members (i.e., a distal end of the cord) and is coupled to a toggle at a free end (i.e., proximal end of the cord). Thus, pulling on the toggle forces the respective frame members to align and engage without the assistance of another person. The frame assembly is preferably assembled as a left half frame assembly and a right half frame assembly according to the toggle pulling method described above. Then, the left and right halves may be coupled together using a structural coupler. These and other aspects of the present invention will be described in greater below.

The present invention of a portable sled and litter, according to at least one embodiment, incorporates, lightweight, abrasion-resistant, interlocking panels, a lightweight telescoping frame assembly, and a inelastic cord that permits the frame assembly to be assembled by a single person without having to physically handle and engage each frame section. In one embodiment, the Portable sled and litter may be Substantially rigid after assembled. The interlocking panels and frame may cooperate to provide high strength lifting points for rigging or transporting the litter. The high-strength lifting points may permit the portable sled and litter to securely hold a patient or gear during a high angle lifting or lowering operations. Advantageously, the portable sled and litter will enhance a caregiver's or operator's ability to move patients, navigate alpine or arctic conditions, and mitigate risk in high angle environments.

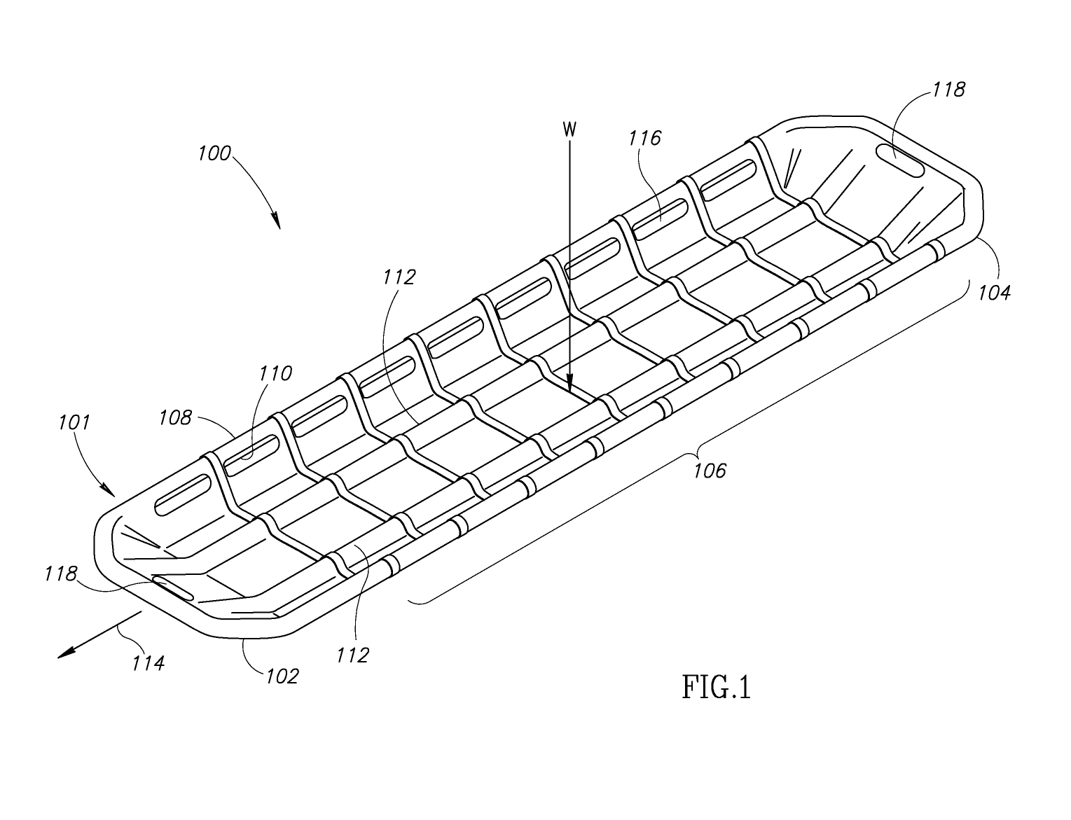

FIG. 1 shows a portable sled and litter 100 in a fully assembled configuration according to an embodiment of the present invention. The portable sled and litter 100 includes a plurality of panels 101 that take the form of, but may not be limited to, a forward panel 102, a rear panel 104 and at least two intermediate panels 106. The illustrated embodiment includes eight (8) intermediate panels, but more or fewer panels may be utilized depending on objectives of the portable sled and litter 100. Each panel 102, 104 and 106 may include a “cupped” or “U” shaped portion 108 configured to receive and transfer load to a frame assembly 110. Each panel 102, 104, 106 may further include one or more protuberances 112 that extend parallel or approximately parallel to a direction of travel 114 of the portable sled and litter 100 after it has been assembled. Because of how the portable sled and litter 100 is assembled, which will be described in greater below, the portable sled and litter 100 will generally have a forward direction of travel 114 that prevents snow or debris from working in between the panels 102, 104 and 106 while also providing a smoother running surface. In one embodiment, one or more of the panels may be made from a fiber reinforced composite material such as, but not limited to, a carbon fiber reinforced composite material. Alternatively to or in combination with the fiber reinforced composite material, one or more of the panels may be made from a polymeric material, which may take the form of a hard plastic material. While not necessarily a preferred options, one or more of the panels may be made from a wood or metallic material.

The panels 102, 104 and 106 may include openings 116 that permit the portable sled and litter 100 to be rigged or lifted, which in turn permits a weight “W” (shown as a point load vector instead of a distributed load for brevity and illustrative purposes) in the portable sled and litter 100 to be transmitted to the frame assembly 110 and then to persons carrying the portable sled and litter 100 (not shown) or to rigging equipment attached to the portable sled and litter 100 (not shown). In one embodiment, the forward panel 102 and the rear panel 104 may include openings 118, which may provide additional carrying or rigging points.

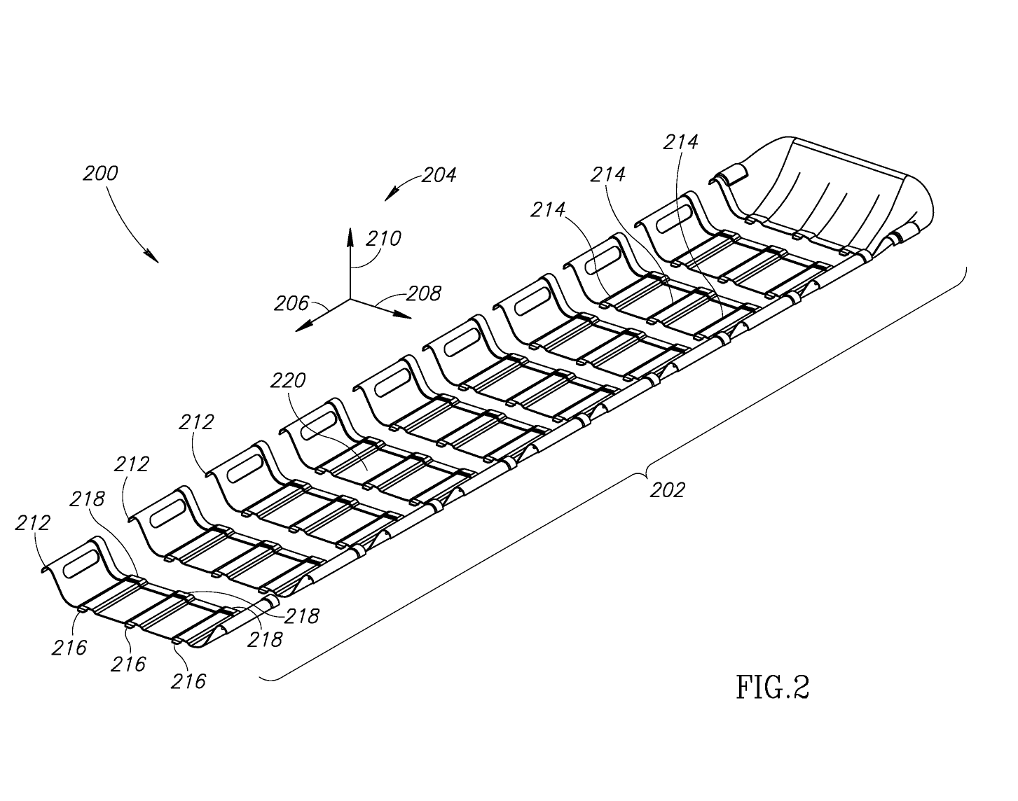

FIG. 2 shows an exploded view of a portable sled and litter 200 according to another embodiment of the present invention. The portable sled and litter 200 includes a plurality of panels 202, which may take the form of a forward panel (not shown), a rear panel and at least two intermediate panels. The illustrated embodiment shows nine (9) intermediate panels, but more or fewer panels may be utilized depending on the objectives of the portable sled and litter 200. For purposes of the description herein, an axis system 204 includes a lengthwise direction 206, a width direction 208 and a vertical direction 210.

Similar to the embodiment shown in FIG. 1, the panels 202 may include a “cupped” or “U” shaped portion 212 for receiving and transferring load to a frame assembly (not shown). In the illustrated embodiment, the panels 202 include three raised protuberances 214 oriented along the lengthwise direction 206 of the portable sled and litter 200. The protuberances 214 are sized and configured to help the portable sled and litter 200 track more efficiently when moving over a malleable surface such as, but not limited, to a snowy terrain. Each panel 202 includes interlocking tabs 216 and all panels 202, except for the rear panel, include tab receiving openings 218. In the illustrated embodiment, each panel 202 includes three interlocking tabs 216, but greater or fewer tabs may be provided in the panels 202. During assembly, each panel 202 is engaged with an adjacent panel 202 by rotating the interlocking tabs 216 into the respective tab receiving openings 218. The applied rotation permits interlocks the panels 202 while advantageously using an upper surface 220 of the panels 202 to limit the amount of applied rotation.

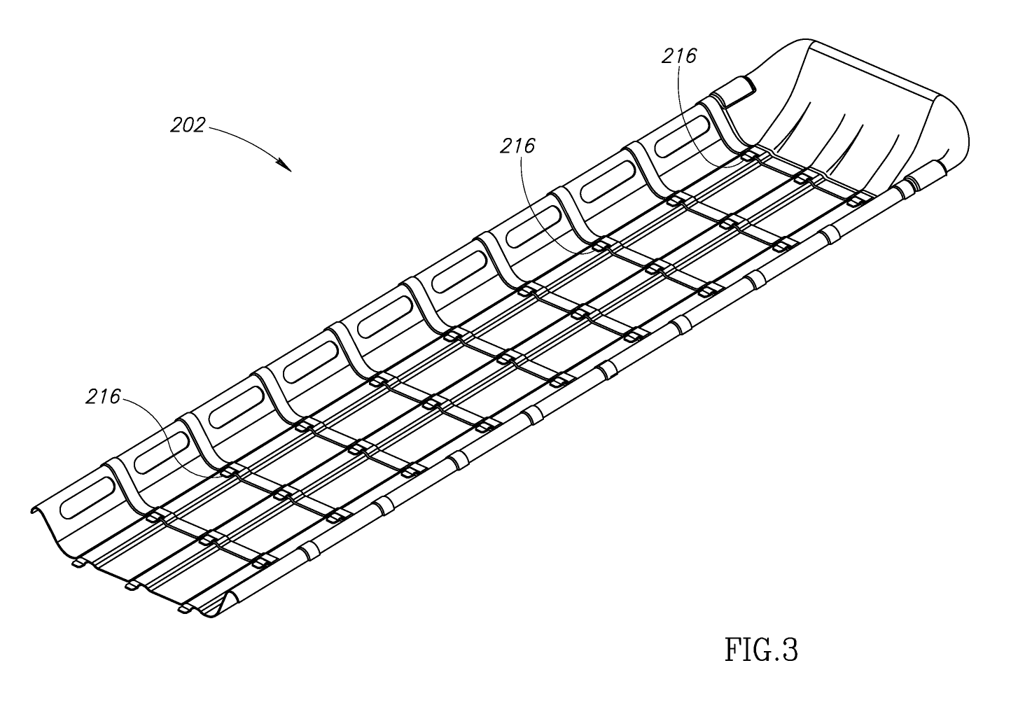

FIG. 3 shows the portable sled and litter 200 in an assembled configuration with the tabs 216 interlocked.

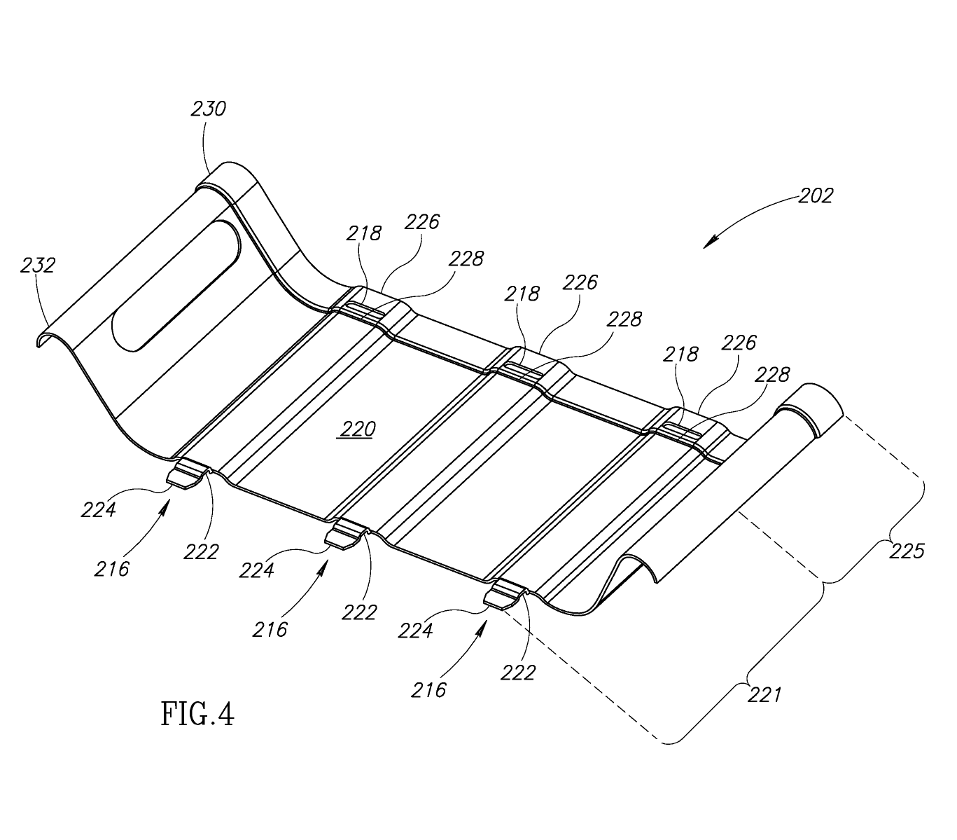

FIG. 4 shows a close-up view of one of the panels 202 according to an embodiment of the present invention. A male engagement side 221 of the panel 202 includes tabs 216 that each have a raised channel 222 and a tongue 224 that extends from the raised channel 222. A female engagement side 225 of the panel 202 includes raised sections 226, the tab receiving openings 218 and tab interlock portions 228.

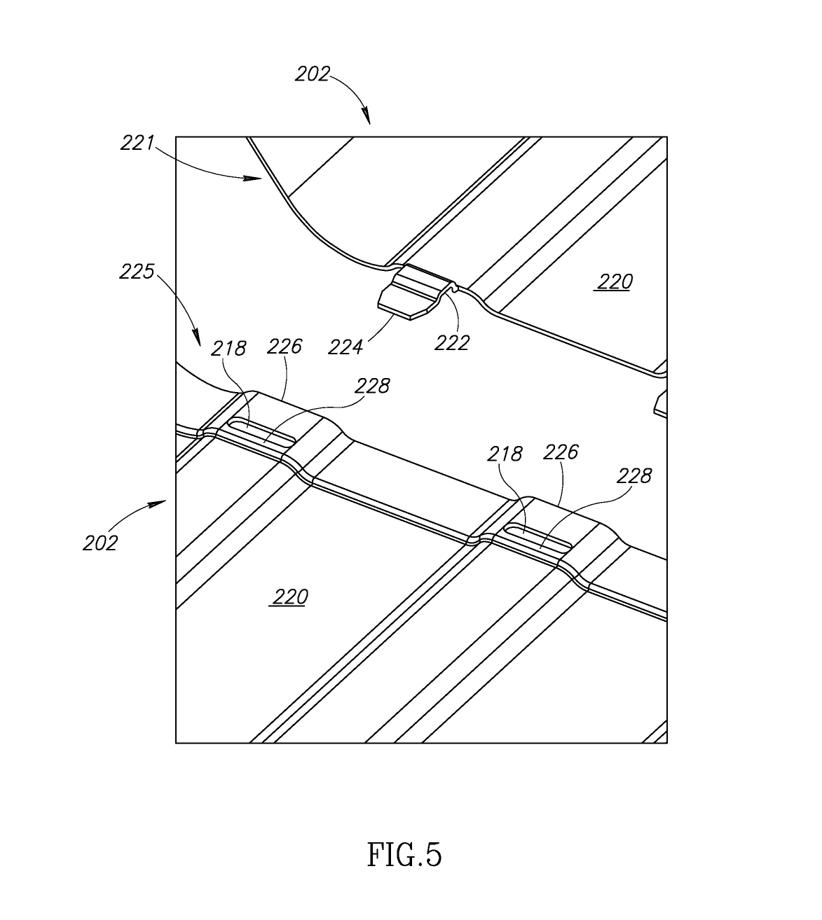

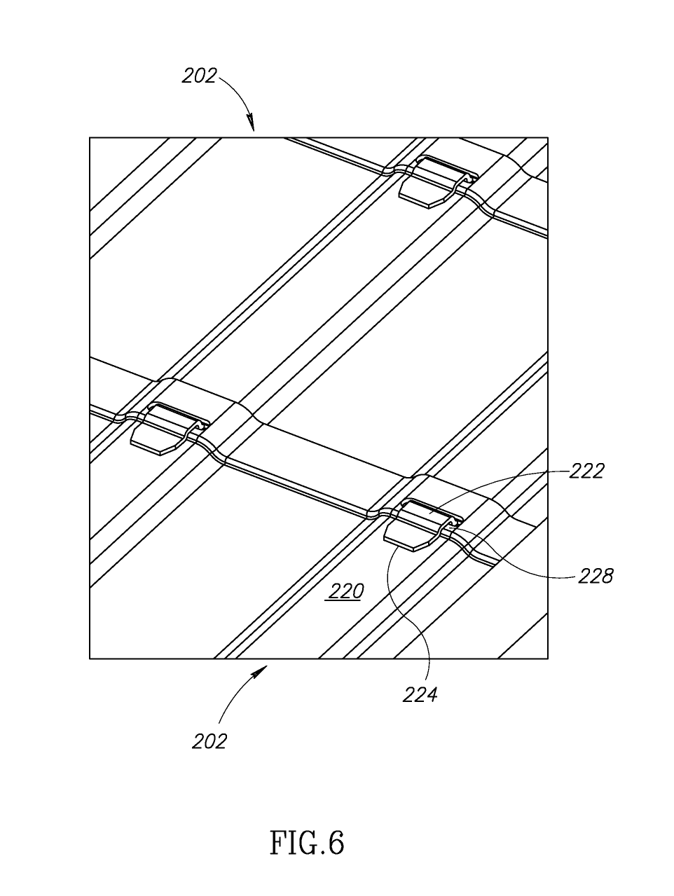

Still referring to FIG. 4 and also now referring to FIGS. 5 and 6, the interlocking aspects of the panels 202 will be described. FIG. 5 shows two panels 202 about to be connected with the male engagement side 221 and female engagement side 225 in close proximity. During assembly (i.e., as the panels are being interlocked together), the tongue 224 and raised channel 222 are rotated up into the tab receiving openings 218. As the panels 202 are rotated to be horizontally aligned with each other, the raised channel 222 receives and interlocks with the tab interlock portion 228 of the raised section 226. In turn, the tongue 224 contacts the upper surface 220, the latter functioning as a rotational limit surface to prevent the inserted panel from continuing to rotate. In one embodiment, the raised section 226 closely receives the raised channel 222 to provide a frictional or snap fit to interlock the panels 202.

FIG. 6 shows the panels 202 interlocked in an assembled configuration. The raised channel 222 is interlocked with the tab interlock portion 228 and the tongue 224 is rotationally leveraged against the upper surface 220 of the panel 202.

Briefly referring back to FIG. 4, the panels 202 may include a raised frame receiving portion 230 configured to closely receive a complementary frame receiving portion 232 of an adjacent panel. In one embodiment, the respective portions 230 and 232 may be snap-fit together.

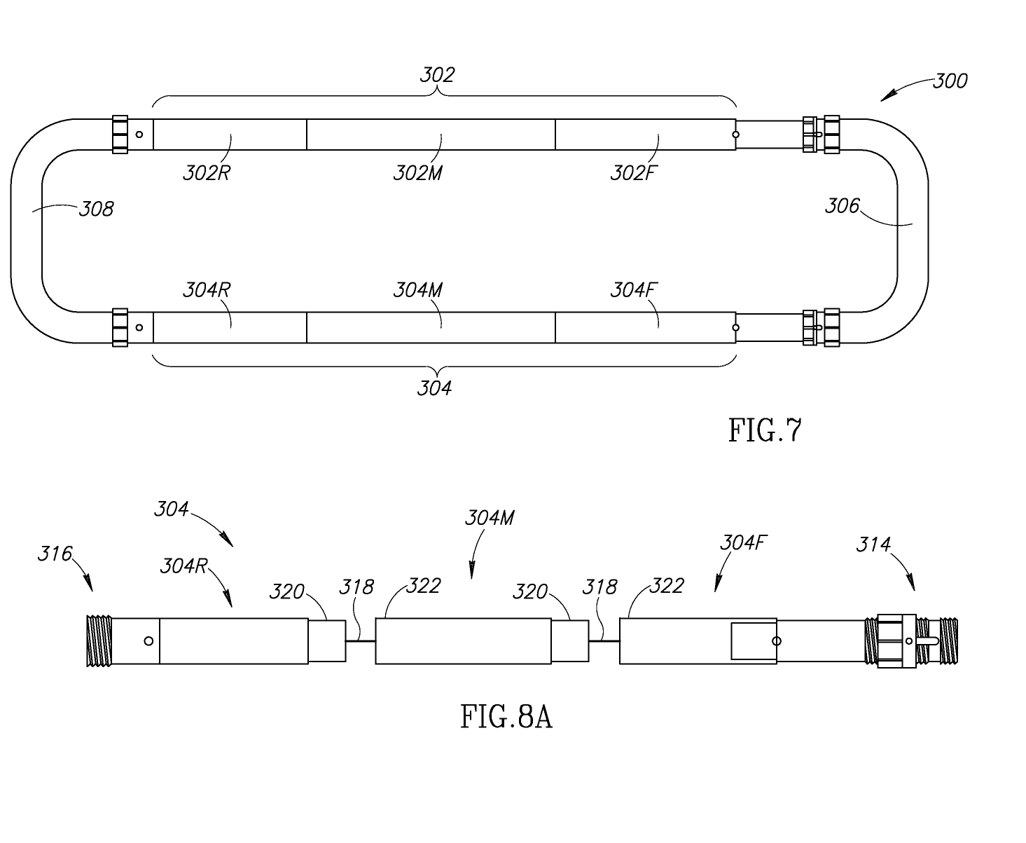

FIG. 7 shows a top plan view of a frame assembly 300 for a portable sled and litter according to an embodiment of the present invention. The frame assembly 300 provides structural support and cooperates with the rigid panels of the portable sled and litter to transfer weight to litter transport personal or rigging equipment. The frame assembly 300 includes at least one left side frame member 302, at least one right side frame member 304, a forward frame member 306, and a rear frame member 308. In the illustrated embodiment, the frame assembly 300 includes three left side frame members 302 and three right side frame members 304, which for purposes of clarity will be referred to as left front side frame member 302F (F=Front), left middle side frame member 302M (M=Middle), and left rear side frame member 302R (R=Rear). Likewise, the right side frame members are labeled in a similar manner as right front side frame member 304F, right middle side frame member 304M, and right rear side frame member 304R. The forward and rear frame members 306, 308, respectively, are single piece components. The frame members may generally be cylindrical or tubular (e.g., circular or nearly circular in cross-section), but may be designed with other shapes (e.g., square or elliptical in cross-section). However, other frame assembly configurations are contemplated herein as will be discussed in the descriptions of following embodiments.

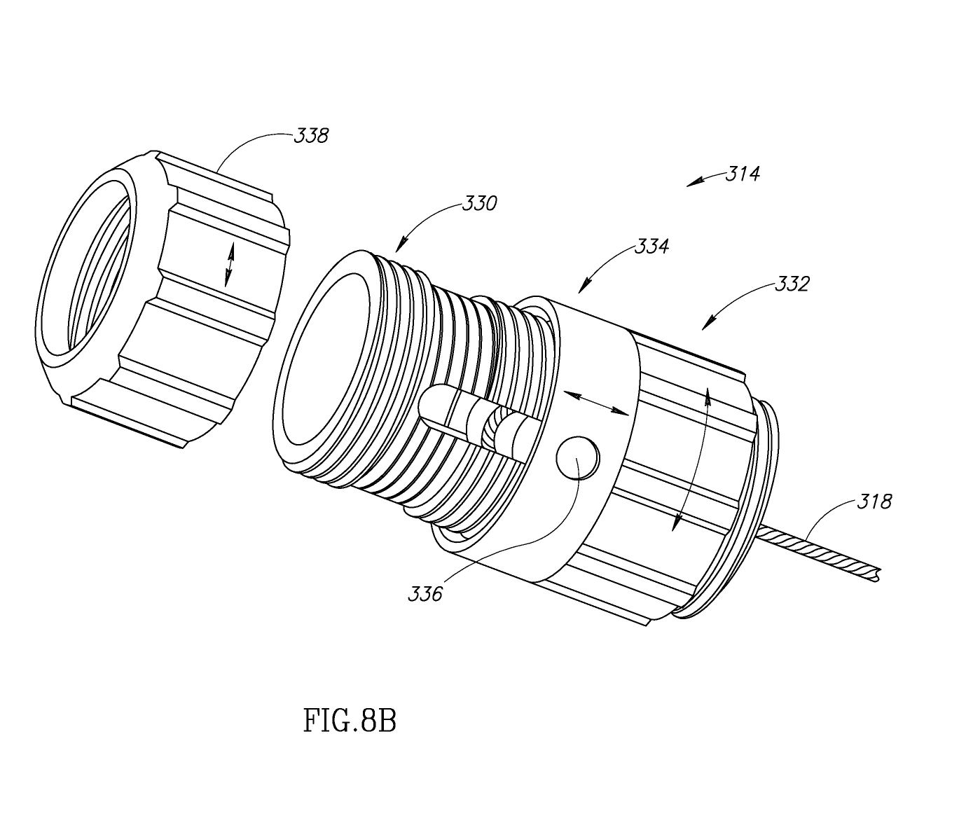

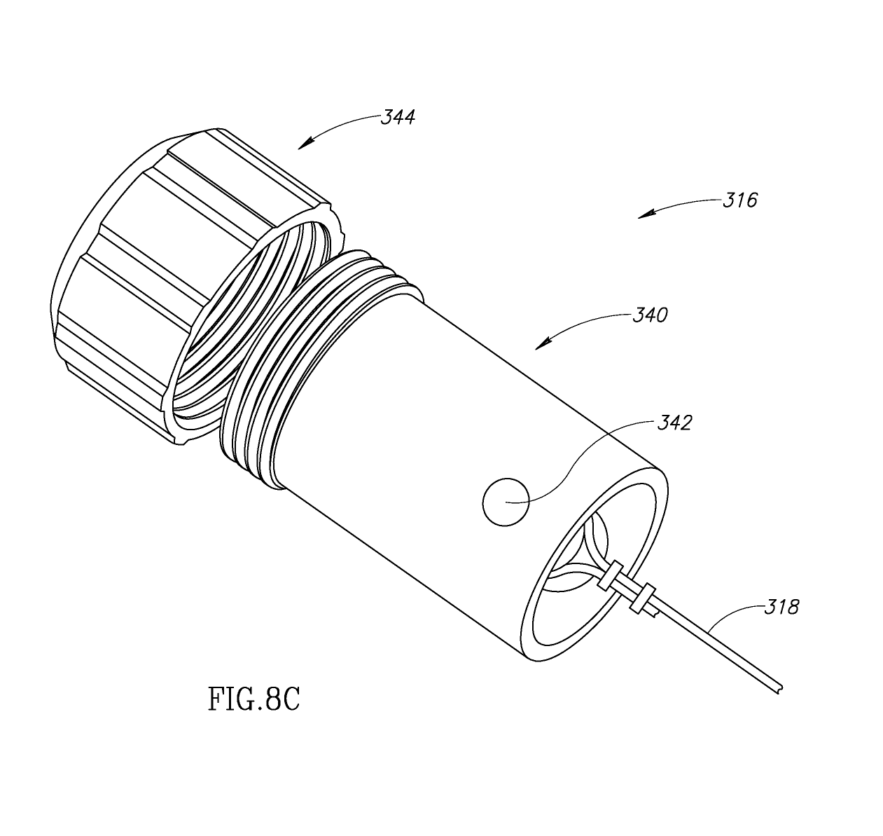

FIG. 8A shows an exploded, side elevational view of the frame assembly 300 of FIG. 7 and in particular shows the right side frame members 304, which are structurally and functionally identical to the left side frame members 302. Each of the side frame members 304 may take the form of an inner tube 310 covered mostly, but not completely, by an outer tube 312. In a preferred embodiment, the inner tube 310 is made from Titanium or a Titanium alloy. However, it is appreciated that the inner tube 310 may be made from a wide variety of materials that could adequately support the panels and weight of the portable sled and litter. Also in the preferred embodiment, the outer tube 312 is made from a carbon fiber reinforced composite material and may be slid on and adhered to the inner tube 310, press fit onto the inner tube 310, or laid up directly on the inner tube 310 and cured in situ. Like the inner tube 310, the outer tube 312 may be made from other materials, such as polymeric, metal, and other types of fiber reinforced composite materials.

The left middle side frame member 304M may be coupled to the other side members 304F 304R, respectively, by applying tension to an inelastic cord or cable 318 that extends through an interior (not shown) of the side frame members 364. In one embodiment, the inelastic cord 304 takes the form of a steel cord, and preferably a stainless steel cord. The cord 318 is fixed to an adjustable coupling 314 and also to a static coupling 316 as will be explained in detail below with the descriptions of FIGS. 8B and 8C.

Still referring to FIG. 8A, FIG. 8B shows the adjustable coupling 314 that couples the left front side frame member 304F with the forward frame member 306 according to the illustrated embodiment. For the frame assembly 300, two adjustable couplings 314 are located on the end portions of the forward frame member 306, but alternatively could be located on the end portions of the rear frame member 308. In either instance the adjustable couplings 314 function to structurally couple the front or rear frame members 306, 308 to the side (straight) members 302, 304.

The adjustable coupling 314 includes a threaded collar 330, a tension nut 332, a tension ring 334, a cross pin 336, and a coupling nut 338. The threaded collar 330 is bonded or otherwise adhered to the side frame member 304F and provides the means for tensioning the interior inelastic cord 318. The tension nut 332, which is rotationally decoupled from the tension ring 334 (i.e., the tension ring 334 does not rotate with the tension nut 332), rotates to advance along the threaded collar 330, and in turn urges (i.e., linearly translates) the tension ring 334. The cross pin 336 is fixed to the tension ring 334, and in turn the inelastic cord 318 is fixed to the cross pin 336, such that the linear movement of the tension ring 334 tensions the inelastic cord 318, which is anchored to the static fitting 316 as explained below. The inelastic cord 318 functions to distribute longitudinal and bending stresses among all of the frame elements, particularly in a vertical lift configuration. The coupling nut 338 may be attached to the frame assembly 300 with a flared tube end and/or an internal tenon (not shown).

Still referring to FIG. 8A, FIG. 8C shows the static coupling 316 that couples the left rear side frame member 304R with the rear frame member 308 according to the illustrated embodiment. For the frame assembly 300, two static couplings 316 are located on the end portions of rear frame member 308, but alternatively could be located on the end portions of the forward frame member 306. In either instance the static couplings 316 function to structurally couple the front or rear frame members 306, 308 to the side (straight) members 302, 304 and provide an anchor point for tensioning the inelastic cord 318.

The static coupling 316 includes a static collar 340 a static cross pin 342 and a static coupling nut 344. The static collar 340 is bonded and pinned to the most outboard side frame member and provides a static attachment point for the inelastic cord 318, which is fixed to the static cross pin 342. Likewise, the static cross pin 342 is structurally fixed to the static collar 340. The static coupling nut 344 may be attached to the frame assembly 300 with a flared tube end and/or an internal tenon (not shown) in the same or similar manner as the adjustable coupling nut 338 was attached.

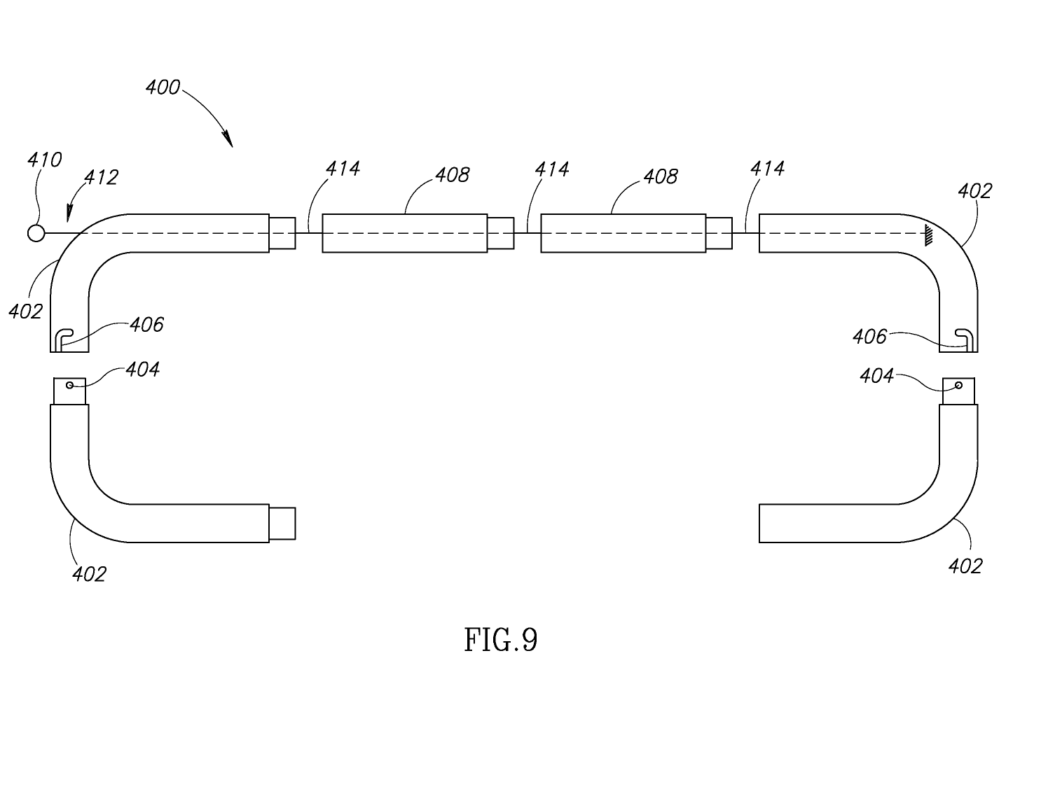

FIG. 9 shows an exploded, top plan view of a frame assembly 400 according to another embodiment of the present invention. End frame members 402 may be coupled together using a detent 404 and a corresponding slot 406. The side frame members 408 are urged together by pulling on a toggle 410, which is fixed to a free end portion 412 of an inelastic cord 414 (Shown in hidden line format as the cord 414 extends through the respective frame members). The pulling action also urges the side frame members 408 into engagement with the end frame members 402. The cord 414 includes a fixed end portion 416 from the free end portion 412. The fixed end portion 416 is connected (shown schematically in FIG. 9) to one of the end frame members 402.

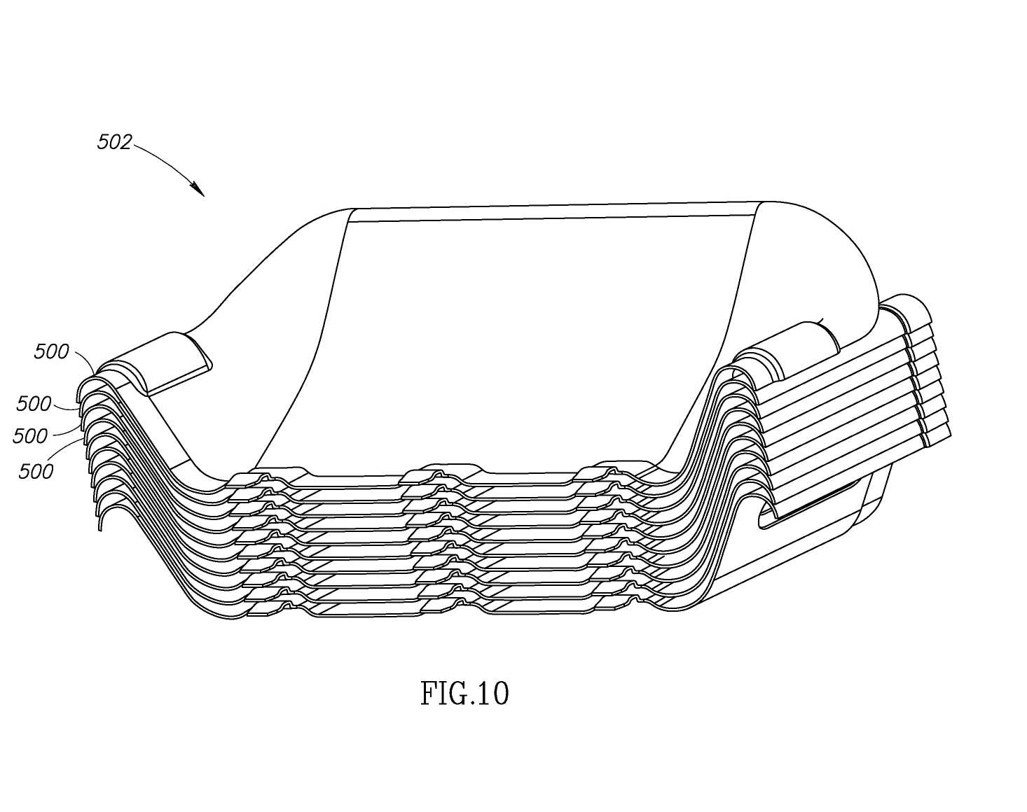

FIG. 10 shows panels 500 in a stacked configuration 502 in accordance with an embodiment of the present invention. The panels 500 may be stacked so they may be stored in and/or transported in a backpack, rucksack, tote, bag, equipment bag or some other bag or container that may be carried by one or more persons.

While the preferred embodiment of the invention been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A portable sled and litter comprising:
a frame assembly having a plurality of telescoping members, at least some of the telescoping members having complementary connectable end portions for engaging with each other;
an inelastic cord extending through the at least some of the telescoping members, the inelastic cord having a distal end and a proximal end, the distal end fixed to a portion of the frame assembly, and the proximal end tensionable to bring the complementary connectable end portions into aligned engagement; and
a plurality of panels releasably engageable with the frame assembly, each panel configured to releasably interlock with at least one adjacent panel.

2. The portable sled and litter of claim 1, further comprising a toggle coupled to the proximal end of the inelastic cord, the toggle pullable to generate tension in the cord.

3. The portable sled and litter of claim 1, wherein at least one of the telescoping members is configured to form a forward portion of the portable sled and litter.

4. The portable sled and litter of claim 1, wherein at least one of the telescoping members is configured to form a rearward portion of the portable sled and litter.

5. The portable sled and litter of claim 1, wherein at least a portion of the frame is made from a fiber reinforced composite material.

6. The portable sled and litter of claim 1, wherein the at least a portion of the frame assembly is made from a metallic material.

7. The portable sled and litter of claim 1, wherein the frame assembly is made from a fiber reinforced composite outer cylindrical member that receives a Titanium inner cylindrical member.

8. The portable sled and litter of claim 1, wherein the complementary connectable end portions include cylindrical male end portions and cylindrical female end portions.

9. The portable sled and litter of claim 1, wherein the inelastic cord is metal.

10. The portable sled and litter of claim 9, wherein the metal inelastic cord is stainless steel.

11. The portable sled and litter of claim 1, wherein at least some of the plurality of panels are rigid panels.

12. The portable sled and litter of claim 1, wherein at least one of the panels includes a tab that interlocks with a tab receiving opening in an adjacent panel.

13. The portable sled and litter of claim 1, wherein at least one of the panels includes at least one protuberance that extends lengthwise and generally in a direction of travel for the portable sled and litter when assembled.

14. The portable sled and litter of claim 1, wherein the at least one protuberance is configured to provide improved tracking of the portable sled and litter when being pulled over a malleable terrain.

15. The portable sled and litter of claim 14, wherein the malleable terrain is snow.

16. The portable sled and litter of claim 1, wherein the plurality of panels being releasably engageable with the frame includes the plurality of panels configured to be snap-fit engageable with the frame.

17. The portable sled and litter of claim 1, wherein at least one of the panels is configured with a cross-sectional shape that cooperates with a travel direction of the portable sled and litter when the portable sled and litter is moved over a malleable terrain.

18. The portable sled and litter of claim 1, wherein the plurality of panels nest with each other when the portable sled and litter is in a disassembled configuration.

19. The portable sled and litter of claim 1, wherein at least one of the plurality of panels is made from a fiber reinforced composite material.

20. A method for assembling a portable sled and litter, the method comprising:
arranging a plurality of frame members on a surface, the frame members comprising a frame assembly for the portable sled and litter;
tensioning an inelastic cord, the cord extending through at least some of the frame members, wherein the tension developed in the cord urges the frame members into an alignable engagement;
interlocking a plurality of panels together to form a rigid litter surface; and
supporting the interlocked plurality of panels on the frame assembly such that load applied onto the panels transfers to the frame assembly.

21. The method of claim 20, wherein tensioning the inelastic cord includes rotating an adjustable coupling.

22. The method of claim 20, wherein interlocking the plurality of panels includes rotating a first panel relative to a second panel such that a tab of the first panel interlocks with a tab receiving opening of the second panel.

23. The method of claim 20, further comprising disassembling the portable sled and litter.

24. The method of claim 23, further comprising arranging the plurality of panels in a nested and stacked configuration.

25. The method of claim 23, further comprising placing the disassembled portable sled and litter into a carrying device that is transportable by a single person.
